(19) United States
(12) Patent Application Publication
(10) Pub. No.: US 2026/0158972 A1
(43) Pub. Date: Jun. 11, 2026

(54) CROSS-CAR AND FORE-AFT POSITIONABLE SEATING SYSTEM

(71) Applicant: FCA US LLC, Auburn Hills, MI (US)

(72) Inventors: Brandon Brady, Auburn Hills, MI (US); Jeffrey Poniatowski, Auburn Hills, MI (US); Travis D Bechtel, Auburn Hills, MI (US); Mark E Stout, III, Auburn Hills, MI (US); Zachary Luetzen, Auburn Hills, MI (US); Santiago Caceres, Auburn Hills, MI (US); Stacy Berger, Auburn Hills, MI (US)

(21) Appl. No.: 18/976,847

(22) Filed: Dec. 11, 2024

(51) Int. Cl. B60N 2/06; B60K 1/04; B60N 2/14

(52) U.S. Cl. CPC B60N 2/062; B60K 1/04; B60N 2/14; B60K 2001/0438

(57) ABSTRACT

A track and latching assembly configured on a vehicle includes a fore-aft track assembly and a cross-car track assembly. The fore-aft track assembly includes first and second fore-aft rails fixed relative to a vehicle floor; and first and second fore-aft tracks configured to slidably translate along the first and second fore-aft rails in a fore-aft direction of the vehicle. The cross-car track assembly includes first and second cross-car rails fixed relative to the first and second fore-aft tracks; and first and second cross-car tracks configured to slidably translate along the first and second cross-car rails in a cross-car direction. The cross-car track assembly is disposed above the fore-aft track assembly permitting movement of the first and second cross-car tracks in the cross-car direction regardless of a position of the first and second fore-aft tracks relative to the first and second fore-aft rails.

### FIELD

The present application relates generally to seating configurations on vehicles and more particularly to a track and latching assembly for a vehicle seat that provides cross-car and fore-aft positioning to achieve a plurality of seating configurations within the vehicle.

### BACKGROUND

Multi-purpose vehicles (MPV's) can be used to transport combinations of occupants and cargo. MPV's are commonly built with seating for two or three rows of occupants and a large cargo-carrying area. Many of these vehicles provide ways to move the interior seats within the vehicle cabin to accommodate a desired number of occupants and/or to achieve a desired cargo space. As such, several configurations exist that allow the rear row(s) of seats to collapse, stow, or otherwise move out of the way to allow additional seating configurations, or to allow the cargo carrying volume to increase. Stowing the second and/or third row seats under the floor of the vehicle is advantageous due to the ability to quickly and conveniently move the seat(s) out of the way. However, this type of design creates a packaging conflict for battery electric vehicles (BEV's) where the high-voltage battery is most commonly packaged below the floor of the vehicle. Stowing a seat underneath the floor of such vehicles would result in an unfeasibly high cabin floor and step-in height for passengers. Another common method of increasing the cargo volume of a two or three row vehicle is to fold the seats flat within the vehicle cabin. While not creating an unnecessarily high floor for passenger ingress/egress, this method results in a high floor when the vehicle seats are folded, reducing cargo space for large cargo, as any large cargo must sit atop the backs of the folded seats. In this regard, while existing seating configurations can be satisfactory, there remains a need for improvement in the relevant art.

### SUMMARY

In accordance with one example aspect of the invention, a track and latching assembly configured on a vehicle includes a fore-aft track assembly and a cross-car track assembly. The fore-aft track assembly includes first and second fore-aft rails fixed relative to a vehicle floor; and first and second fore-aft tracks configured to slidably translate along the first and second fore-aft rails in a fore-aft direction of the vehicle. The cross-car track assembly includes first and second cross-car rails fixed relative to the first and second fore-aft tracks; and first and second cross-car tracks configured to slidably translate along the first and second cross-car rails in a cross-car direction including a driver side cross-car direction and a passenger side cross-car direction. The cross-car track assembly is disposed above the fore-aft track assembly permitting movement of the first and second cross-car tracks in the cross-car direction regardless of a position of the first and second fore-aft tracks relative to the first and second fore-aft rails.

In addition to the foregoing, the vehicle includes a first row of seats, a second row of seats, and a third row of seats.

In addition to the foregoing, the track and latching assembly is configured on a driver's side seat of the second row of seats.

In addition to the foregoing, the track and latching assembly is configured on a passenger's side seat of the second row of seats.

In addition to the foregoing, the vehicle is a battery electric vehicle.

In other examples, the vehicle further includes a high voltage battery positioned under a floor of the vehicle below the track and latching assembly.

In addition to the foregoing, the fore-aft track assembly is disposed in the floor above the high voltage battery.

In examples, the track and latching assembly further includes a latching member rotatably coupled relative to the driver's side seat of the second row of seats, the latching member including an arm, a biasing member and a first engagement member.

In other examples, the vehicle further comprises a first loop extending relative to the vehicle floor, wherein the first engagement member is configured to engage the first loop to fix the driver's side seat relative to the first and second rails of the cross-car track assembly in a first cross-car position.

In some implementations, the vehicle further comprises a second loop extending relative to the vehicle floor, wherein the first engagement member is configured to engage the second loop to fix the driver's side seat relative to the first and second rails of the cross-car track assembly in a second cross-car position, wherein the second cross-car position is in the passenger side cross-car direction and distinct from the first cross-car position.

In other examples, the driver's side seat of the second row of seats further comprises a rotation mechanism that permits rotation of the driver's side seat of the second row of seats.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is top view of a multi-purpose vehicle and shown having first and second track and latching assemblies constructed according to the principles of the present disclosure;

FIG. 2A is a top perspective view of a portion of the first track and latching assembly of FIG. 1 and shown in a first cross-car position according to the principles of the present disclosure;

FIG. 2B is a front view of the first track and latching assembly of FIG. 2A according to the principles of the present disclosure;

FIG. 2C is a top perspective view of a portion of the first track and latching assembly of FIG. 1 and shown in a second cross-car position according to the principles of the present disclosure;

FIG. 2D is a front view of the first track and latching assembly of FIG. 2C according to the principles of the present disclosure;

FIG. 3 is a top view of the multi-purpose vehicle of FIG. 1 and shown in a first exemplary seating configuration according to the principles of the present disclosure;

FIG. 4 is a top view of the multi-purpose vehicle of FIG. 1 and shown in a second exemplary seating configuration according to the principles of the present disclosure;

FIG. 5 is a top view of the multi-purpose vehicle of FIG. 1 and shown in a third exemplary seating configuration according to the principles of the present disclosure;

FIG. 6 is a top view of the multi-purpose vehicle of FIG. 1 and shown in a fourth exemplary seating configuration according to the principles of the present disclosure;

FIG. 7 is a top view of the multi-purpose vehicle of FIG. 1 and shown in a fifth exemplary seating configuration according to the principles of the present disclosure;

FIG. 8 is a top view of the multi-purpose vehicle of FIG. 1 and shown in a sixth exemplary seating configuration according to the principles of the present disclosure;

FIG. 9 is a top view of the multi-purpose vehicle of FIG. 1 and shown in a seventh exemplary seating configuration according to the principles of the present disclosure;

FIG. 10 is a top view of the multi-purpose vehicle of FIG. 1 and shown in an eighth exemplary seating configuration according to the principles of the present disclosure;

FIG. 11 is a top view of the multi-purpose vehicle of FIG. 1 and shown in a ninth exemplary seating configuration according to the principles of the present disclosure; and

FIG. 12 is a top view of the multi-purpose vehicle of FIG. 1 and shown in a tenth exemplary seating configuration according to the principles of the present disclosure.

### DESCRIPTION

As previously discussed, several configurations exist in MPV's that allow the rear row(s) of seats to collapse, stow, or otherwise move out of the way to allow additional seating configurations inside a vehicle, or to allow the cargo carrying volume to increase. Stowing the second and/or third row seats under the floor of the vehicle is advantageous due to the ability to quickly and conveniently move the seat(s) out of the way. However, this type of design creates a packaging conflict for battery electric vehicles (BEV's) where the high-voltage battery is most commonly packaged below the floor of the vehicle.

The present disclosure provides track and latching assemblies configured for use with vehicle seats within the MPV. The track and latching assemblies are configured for use with seats in the second row of the MPV. The track and latching assemblies allow the second row of seats to be independently translated in the fore-aft directions and the cross-car directions. In particular, the track and latching assemblies allow the second row of seats to be moved in the cross-car directions regardless of where they are positioned on the respective track in the fore-aft position.

The second row of seats can be stowed out of the way to enable re-configuration of the vehicle cabin, transport of large cargo and/or moved in the cross-car and fore-aft directions to allow for easy ingress/egress. The track and latching assemblies are designed for vehicles where stowing the seat under the vehicle floor of the vehicle is not feasible due to packaging constraints, which may include the presence of a high voltage battery under the floor of the vehicle. Furthermore, the track and latching assemblies allow for the grouping of several seats and functions of those seats to create an optimal interior interaction for the user in the vehicle architecture that does not allow for the seats to be stowed under the floor.

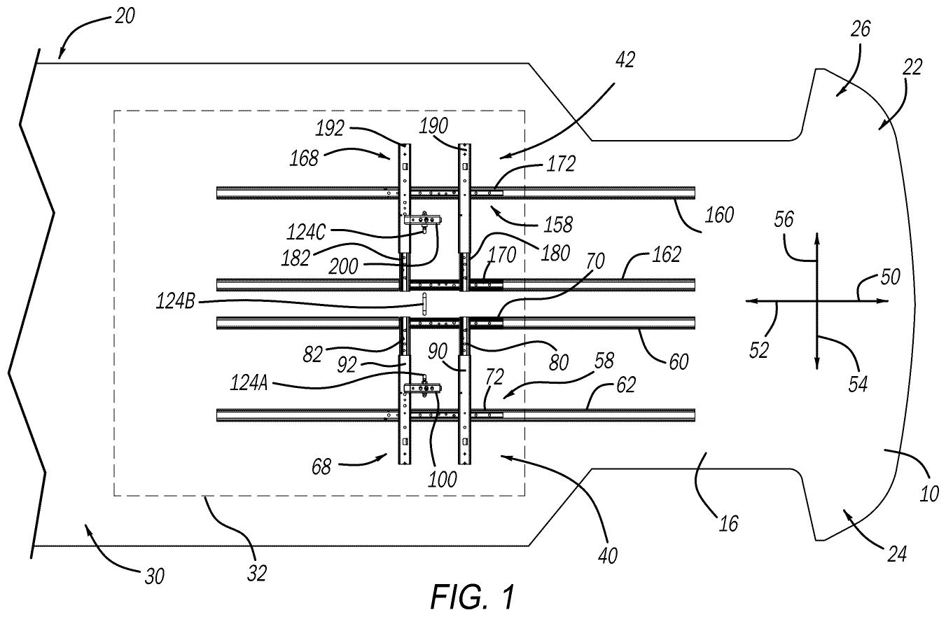

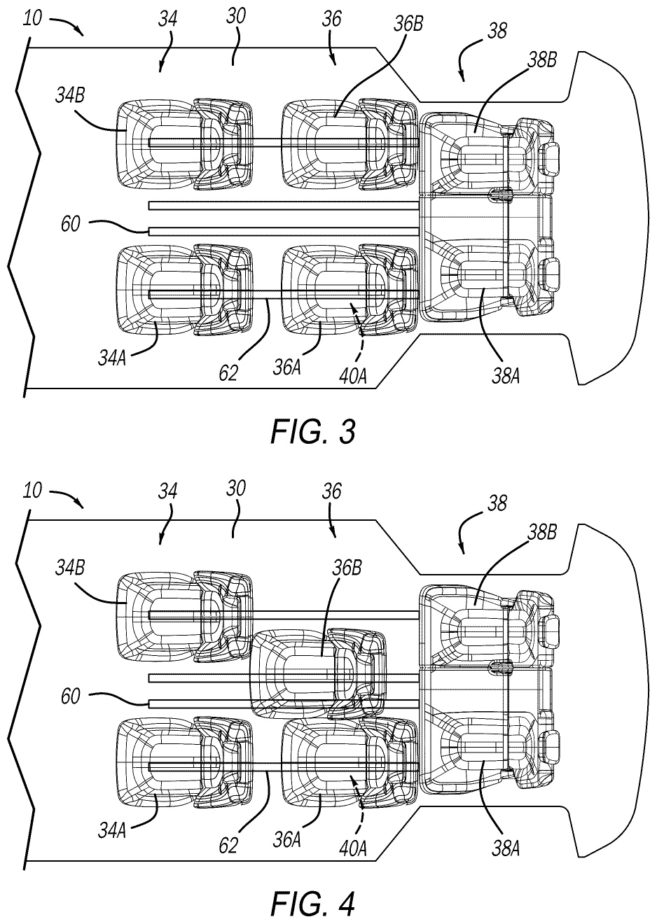

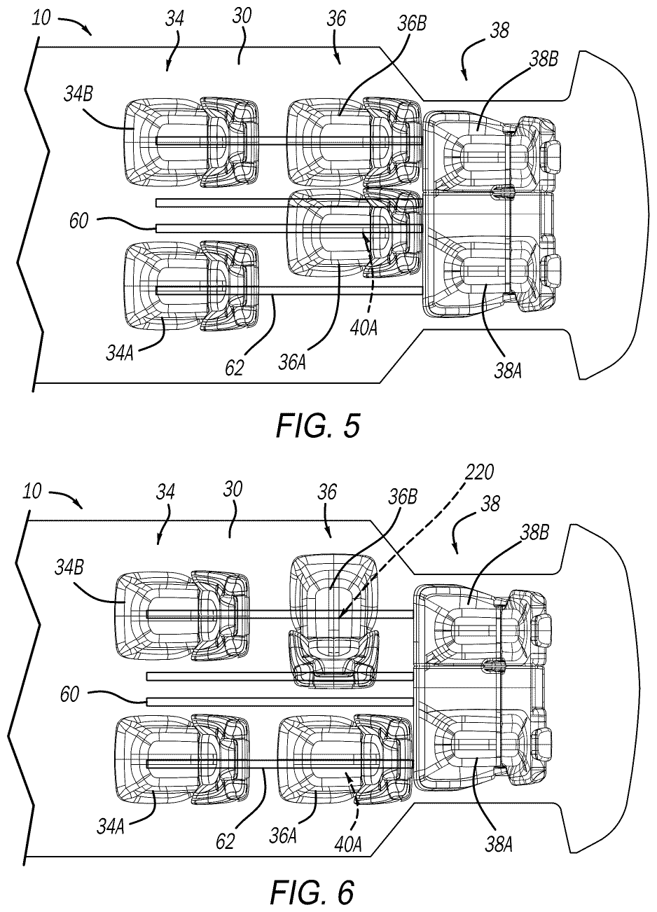

Referring now to FIGS. 1 and 3, a multi-purpose vehicle (MPV) constructed in accordance to one examples of the present disclosure is shown and generally identified at reference numeral 10. The MPV 10 generally includes a vehicle body 16 that extends between a front end 20, a rear end 22, a driver side 24 and a passenger side 26. The vehicle body 16 generally comprises a vehicle floor 30. In the exemplary configuration, a high voltage battery 32 is positioned beneath the floor 30 for powering one or more electric motors (not shown).

As will become appreciated from the following discussion, the MPV 10 includes a first row of seats 34 including a driver seat 34A, and a passenger seat 34B; a second row of seats 36 including a second row driver side seat 36A, and a second row passenger side seat 36B; and a third row of seats 38 including a third row driver side seat 38A and a third row passenger side seat 38B. The second and third row of seats 36, 38 can be deployed in multiple positions (seating position, folded position stored in the floor) to provide various seating configurations useful for occupant seating, cargo accommodating and occupant egress and ingress.

The MPV 10 includes a first track and latching assembly 40 and a second track and latching assembly 42. In the example provided, the first track and latching assembly 40 is positioned on the driver side 24 while the second track and latching assembly 42 is positioned on the passenger side 26. As will be described in greater detail herein, the first and second track and latching assemblies 40 and 42 allow first and second seats arranged along a second row of seats of the MPV 10 to move in the fore direction 50, the aft direction 52, the driver side cross car direction 54 and the passenger side cross car direction 56.

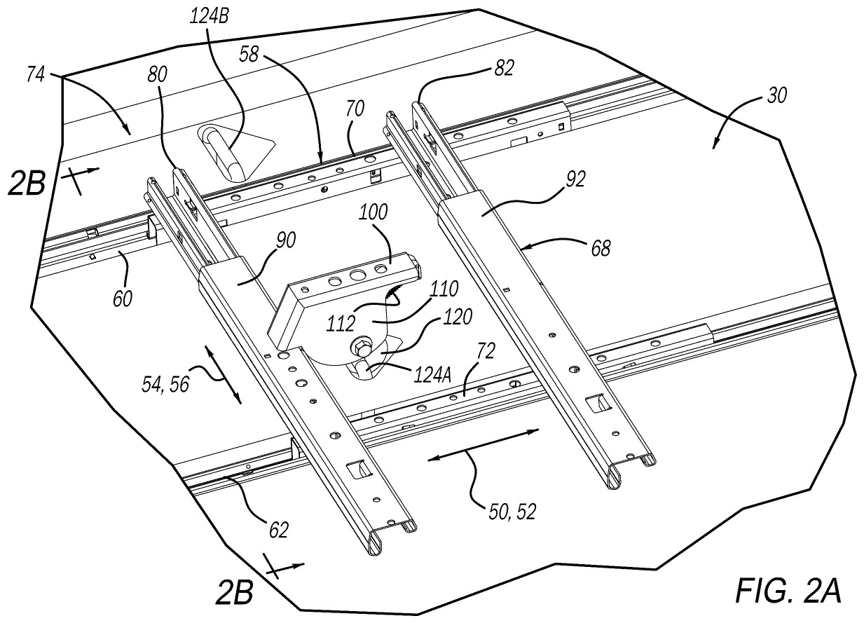

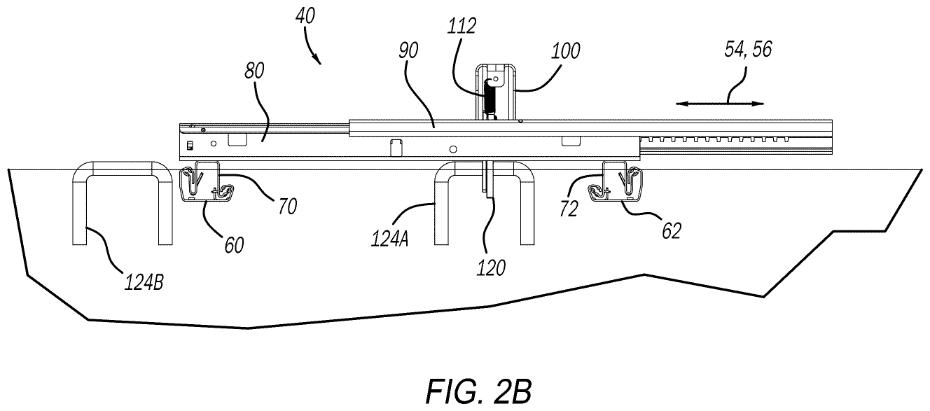

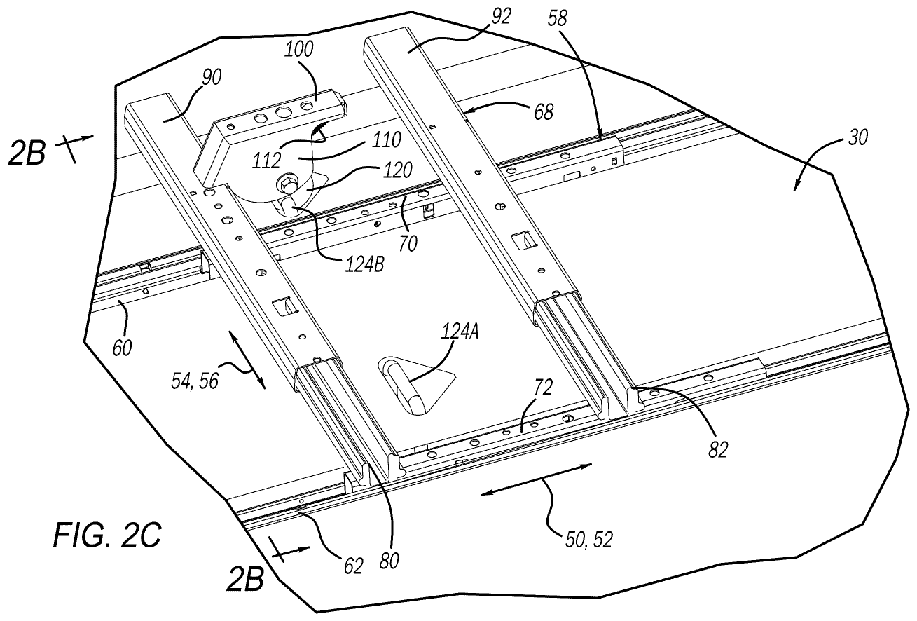

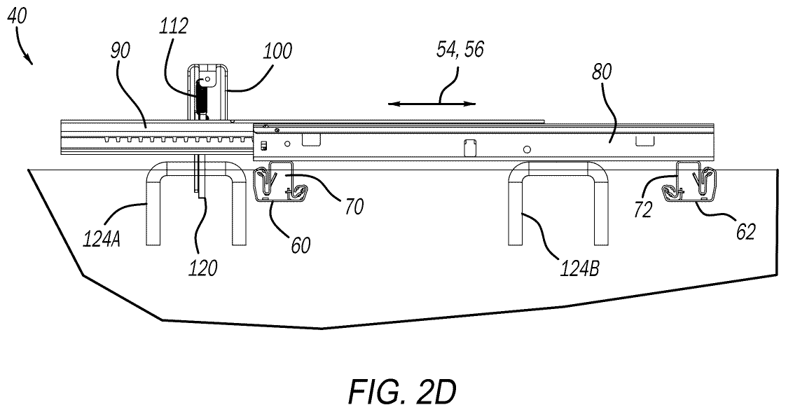

With continued reference to FIGS. 1 and 3 and additional reference now to FIG. 2A, the first track and latching assembly 40 will be described with the understanding that the second track and latching assembly 42 is constructed similarly. The first track and latching assembly 40 includes a fore-aft track assembly 58 and a cross-car track assembly 68. The fore-aft track assembly 58 includes first and second fore-aft rails 60 and 62 and first and second fore-aft tracks 70 and 72. The first and second fore-aft rails 60 and 62 are generally fixed relative to the vehicle floor. The first and second fore-aft tracks 70 and 72 are configured to slidably translate along the first and second fore-aft rails 60 and 62 in the fore direction 50 and the aft direction 52.

The cross-car track assembly 68 of the first track and latching assembly 40 includes first and second cross-car rails 80 and 82 and first and second cross-car tracks 90 and 92. The first and second cross-car rails 80 and 82 are generally fixed relative to the first and second fore-aft tracks 70 and 72. The first and second cross-car tracks 90 and 92 are configured to slidably translate along the first and second cross-car rails 80 and 82 in the driver side cross-car direction 54 and the passenger side cross-car direction 56.

A first latching member 100 is rotatably coupled relative to the second row driver side seat 36A. The first latching member 100 includes an arm 110, a biasing member 112 and a first engagement member or hook 120. In a first cross-car position (FIGS. 2A and 2B), the biasing member 112 normally biases the arm 110 into engagement with a second engagement member or loop 124A extending from the floor 30. In a second cross-car position (FIGS. 2C and 2D), the biasing member 112 normally biases the arm 110 into engagement with a second engagement member or loop 124B extending from the floor 30.

Returning now to FIG. 1, the second track and latching assembly 42 includes a fore-aft track assembly 158 and a cross-car track assembly 168. The fore-aft track assembly 158 includes first and second fore-aft rails 160 and 162 and first and second fore-aft tracks 170 and 172. The first and second fore-aft rails 160 and 162 are generally fixed relative to the vehicle floor. The first and second fore-aft tracks 170 and 172 are configured to slidably translate along the first and second fore-aft rails 160 and 162 in the fore direction 50 and the aft direction 52.

The cross-car track assembly 168 of the second track and latching assembly 42 further includes first and second cross-car rails 180 and 182 and first and second cross-car tracks 190 and 192. The first and second cross-car rails 180 and 182 are generally fixed relative to the first and second fore-aft tracks 170 and 172. The first and second cross-car tracks 190 and 192 are configured to slidably translate along the first and second cross-car rails 180 and 182 in the driver side cross-car direction 54 and the passenger side cross-car direction 56.

A second latching member 200 is rotatably coupled relative to the second row driver side seat 36B. The second latching member 200 is constructed similarly to the first latching member 100 and includes an arm, a biasing member and a second engagement member or hook. The second latching member 200 can be biased into engagement with a third loop 124C in a first cross-car position (with the second row seat 36B in the position shown in FIGS. 1 and 3), or biased into engagement with the second loop 124B in a second cross-car position (with the second row seat 36B in the position shown in FIG. 4). In this regard, the second loop 124B can be engaged with the first latching member 100 or the second latching member 200.

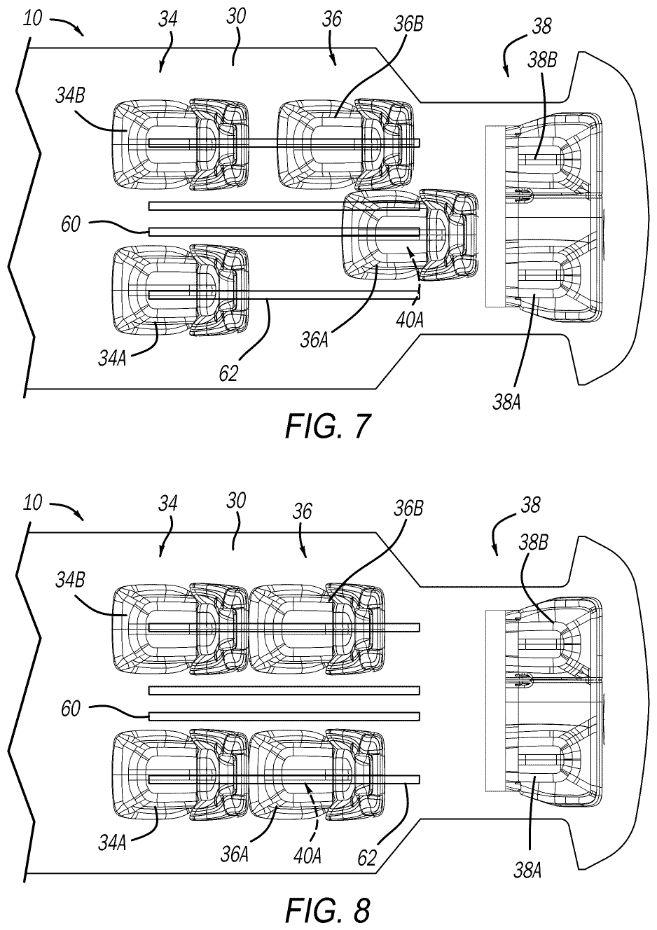

With reference now to all FIGS., additional features of the present disclosure will be further discussed. The configuration of the first and second track and latching assemblies 40 and 42 provide many advantages over prior art configurations. In particular, because the cross-car track assembly 68 (first and second cross-car rails 80 and 82 and tracks 90 and 92) are disposed above the fore-aft track assembly 58 (first and second fore-aft rails 60 and 62 and tracks 70 and 72), the seats 36A and 36B can move in the cross-car directions (54, 56) regardless of where they are located fore-aft (e.g. along the rails 60 and 62). In this regard, the second row driver side seat 36A can be easily pushed in the passenger side cross-car direction 56 by unlatching the first latching member 100 and translating the seat 36A (see for example FIG. 7) in the passenger side cross-car direction 56.

Similarly, the second row passenger side seat 36B can be easily pushed in the driver side cross-car direction 54 by unlatching the second latching member 200 and translating the seat 36B (see for example FIG. 4) in the driver side cross-car direction 54. It will be appreciated that the seats 36A and 36B can be moved cross-car and at any fore-aft position. If the seats 36A and 36B occupy a different fore-aft position they both can be moved inboard. However, only one seat 36A and 36B can be positioned in the center position and be ridden in. In examples, moving one of the second row seats 36 can be useful during school pick up or other circumstance where extra space on the floor 30 is desired near the second row of seats 36 such as when access to the third row of seats 38 is desired (or extra storage space on the floor 30 is needed).

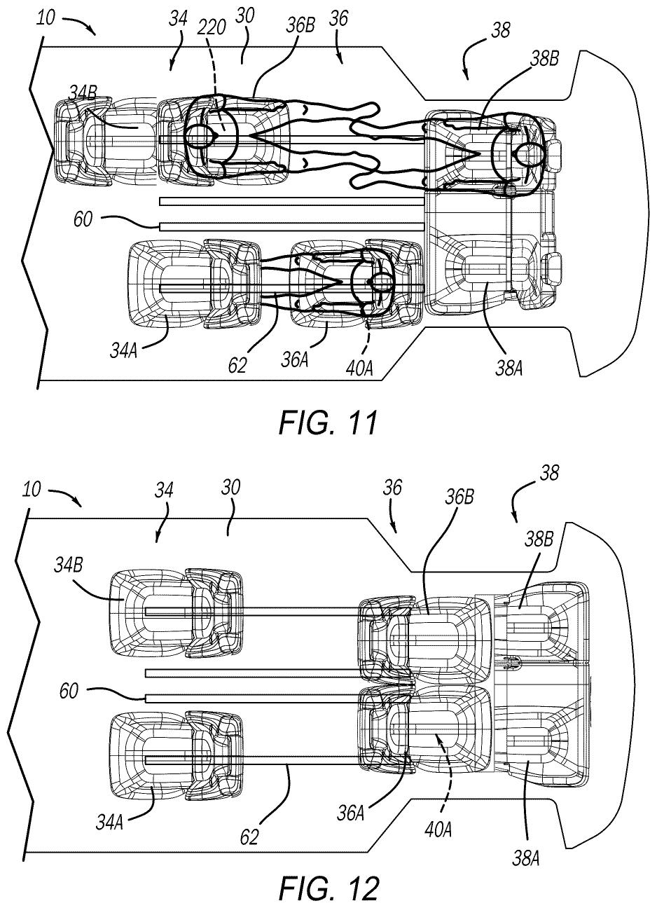

The second row seats 36A and 36B can be moved to various fore-aft and cross-car positions to satisfy various cargo carrying or occupant socialization objectives. The interior of the MPV 10 can be easily reconfigured for additional space without removing the seats from the vehicle 10. In additional examples, the seats 36A, 36B can swivel around a rotation mechanism 220 such as to a 90 degree position (see seat 36B, FIG. 6) or a 180 degree position (see seat 36B, FIG. 11).

The seating configurations offered by the MPV 10 allows for maximum on the fly reconfigurability in an architecture that has underbody packaging constraints such as the high voltage battery 32. It provides a large interior cargo storage capability by being able to store the third row seats 38 in the floor 30 while being able to move the second row seats 36 all the way up to the back of the front row seats 34 while the second row seats 36 are in a stadium storage position (see for example, FIG. 8). It further allows for maximum sociability by allowing a second row seat 36 (see seat 36B, FIG. 11) to rotate about the rotation mechanism 220 around 180 degrees, while the third-row seats 38 are stored in the floor 30.

The second row seat 36 can be moved inboard clearing the quarter trim and rearward to where the third row seat 38 previously occupied (see for example, FIG. 12). In one socialization seating arrangement in FIG. 11, two occupants can face each other in the cabin environment without having to struggle over where to put each other's legs. The configuration of the MPV 10 provides an improved accessibility of the third row seats 38. For example, whin the second row seat 36 moved inboard and then forward, it provides the maximum opening for someone trying to get into the third-row seat 38 (see for example, FIG. 4).

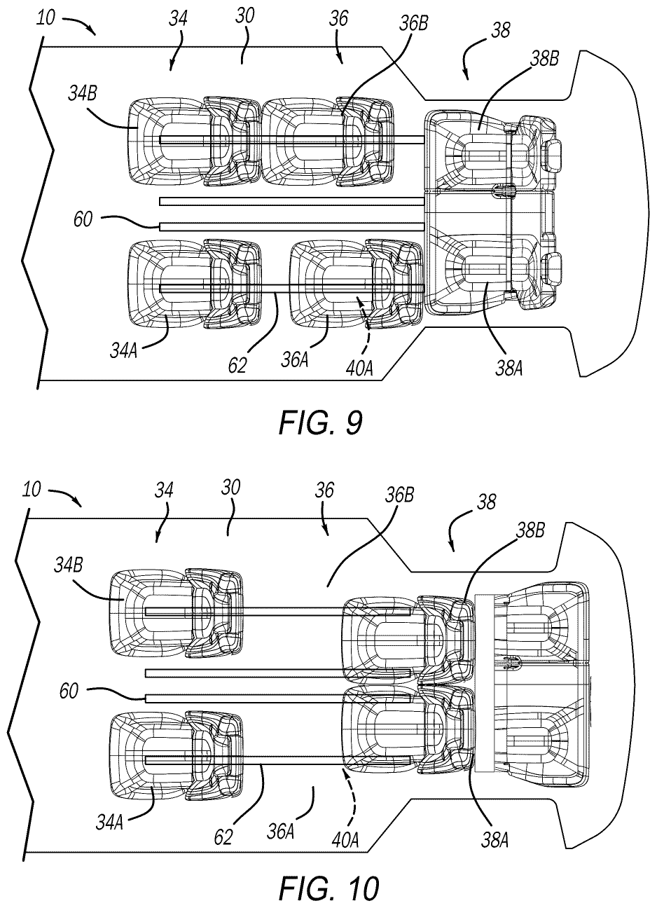

Further to the above discussion, the track and latching assemblies 40 and 42 provides improved cargo transportation, socialization and ingress/egress. For example, the collection of seats 34, 36, 38 allows for maximum reconfiguration, which provides maximum cargo transportation. In a first example, a user can move one of the second row seats 36A, 36B forward and inboard while in stadium position (FIGS. 8 and 9) to nest up against the first row seats 34 enabling the user to put a large object (for example a dog kennel, etc.) in the second row door opening. In a second example, when a user needs maximum cargo volume, the third row seats 38 can be stored in the floor 30 while the second seats 36 can be moved as far forward as possible along the fore-aft track assembly 58 (FIG. 8).

The collection of seats 34, 36 and 38 allows for the second row seats 36 to move rearward and swivel 180 degrees to be rearward facing (see for example, FIG. 12). In a conventional first and second row seat layout, the occupants of the first and second row seats can compete for available leg room. The present configuration, such as shown in FIG. 12, allows for the third row of seats 38 to be stored and the second row seats 36 to be moved rearward to essentially the space vacated by the third row seat 38. This enables maximum distance between the first and second row occupant providing a comfortable seating position for both occupants.

The collection of seats 34, 36 and 38 allows convenient ingress/egress to the third row of seats 38 when it is otherwise inconvenient or difficult. The floor height of the vehicle 10 in combination with a low roof line provide a difficult navigation from the second row door to a seated position in a third row (or vice-versa). The present configuration allows the second row seat 36 to move inboard and forward providing the largest available distance from the second row seat 36 to the quarter panel while also providing the most direct route to get into or out of a third row seat 38. With most of the second row seat 36 out of the way, the ability to move from the door opening to the third row seat 38 (and vice-versa) are as direct as possible. Another advantage provided by the collection of seats 34, 36 and 38 is the ability to maintain a car or child seat in the second row seat 36 while moving. This prevents the need to remove a car or child seat to gain easy and/or unencumbered access to the third row of seats 38.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present disclosure, its application or uses. Thus, variations that do not depart from the gist of the present disclosure are intended to be within the scope of the present disclosure.

What is claimed is:

1. A track and latching assembly configured on a vehicle, the track and latching assembly comprising:
a fore-aft track assembly comprising:
first and second fore-aft rails fixed relative to a vehicle floor; and
first and second fore-aft tracks configured to slidably translate along the first and second fore-aft rails in a fore-aft direction of the vehicle;
a cross-car track assembly comprising:
first and second cross-car rails fixed relative to the first and second fore-aft tracks; and
first and second cross-car tracks configured to slidably translate along the first and second cross-car rails in a cross-car direction including a driver side cross-car direction and a passenger side cross-car direction; and
wherein the cross-car track assembly is disposed above the fore-aft track assembly permitting movement of the first and second cross-car tracks in the cross-car direction regardless of a position of the first and second fore-aft tracks relative to the first and second fore-aft rails.

2. The track and latching assembly of claim 1, wherein the vehicle includes a first row of seats, a second row of seats, and a third row of seats.

3. The track and latching assembly of claim 2, wherein the track and latching assembly is configured on a driver's side seat of the second row of seats.

4. The track and latching assembly of claim 2, wherein the track and latching assembly is configured on a passenger's side seat of the second row of seats.

5. The track and latching assembly of claim 1, wherein the vehicle is a battery electric vehicle.

6. The track and latching assembly of claim 5, wherein the vehicle further includes a high voltage battery positioned under the vehicle floor below the track and latching assembly.

7. The track and latching assembly of claim 6, wherein the fore-aft track assembly is disposed in the vehicle floor above the high voltage battery.

8. The track and latching assembly of claim 3, further comprising:
a latching member rotatably coupled relative to the driver's side seat of the second row of seats, the latching member including an arm, a biasing member and a first engagement member.

9. The track and latching assembly of claim 8, wherein the vehicle further comprises a first loop extending relative to the vehicle floor, wherein the first engagement member is configured to engage the first loop to fix the driver's side seat relative to the first and second rails of the cross-car track assembly in a first cross-car position.

10. The track and latching assembly of claim 9, wherein the vehicle further comprises a second loop extending relative to the vehicle floor, wherein the first engagement member is configured to engage the second loop to fix the driver's side seat relative to the first and second rails of the cross-car track assembly in a second cross-car position, wherein the second cross-car position is in the passenger side cross-car direction and distinct from the first cross-car position.

11. The track and latching assembly of claim 3, wherein the driver's side seat of the second row of seats further comprises a rotation mechanism that permits rotation of the driver's side seat of the second row of seats.
